(19) United States
(12) Patent Application Publication
(10) Pub. No.: US 2016/0070517 A1
(43) Pub. Date: Mar. 10, 2016

(54) METHOD TO PROCESS A SOURCE PDF FILE

(71) Applicant: Oce Printing Systems GmbH & Co. KG, Poing (DE)

(72) Inventors: Oliver Hoffmann, Isen (DE); Robert Wallner, Neuried (DE)

(73) Assignee: Oce Printing Systems GmbH & Co. KG, Poing (DE)

(21) Appl. No.: 14/847,145

(22) Filed: Sep. 8, 2015

(30) Foreign Application Priority Data
Sep. 8, 2014 (DE) 102014112859.1

(51) Int. Cl. G06F 3/12

(52) U.S. Cl. CPC G06F 3/1247; G06F 3/1206; G06F 3/1248

(57) ABSTRACT

In a method to print a source PDF file with at least one reference to an external object, initially determining whether at least one reference to an external object is included in the source PDF file. If so, a target PDF file is generated wherein, in addition to information of the source PDF file, all referenced external objects are included in the target PDF file in an embedded form. The target PDF file is converted into print data and the target PDF file is printed.

### BACKGROUND

The disclosure concerns a method for processing a source PDF file, with the aid of which method PDF files with references to external objects may also be processed.

The widespread PDF format for documents offers the capability of referencing external objects within a PDF file. For example, these may be pages of external PDF files, images and/or an ICC profile. For this, a kind of form into whose fields the objects from the external file are to be inserted is included in the PDF file. The referencing of external objects is in particular defined in the “PDF-VT2” PDF standard.

The printing of such PDF files with external references has previously not been possible and regularly leads to problems since the insertion of the referenced external objects into the processing of the source PDF file does not function without error. Even the display of a PDF file with such references to external objects does not work, or works only with a significant effort. Accordingly, a further processing is only possible with even greater difficulty.

### SUMMARY

It is an object of the invention to specify a method for processing a source PDF file, with the aid of which method a processing of the source PDF file is possible even if this includes references to external objects.

In a method to print a source PDF file with at least one reference to an external object, initially determining whether at least one reference to an external object is included in the source PDF file. If so, a target PDF file is generated wherein, in addition to information of the source PDF file, all referenced external objects are included in the target PDF file in an embedded form. The target PDF file is converted into print data and the target PDF file is printed.

### BRIEF DESCRIPTION OF THE DRAWINGS

FIG. 1 is a workflow diagram of a method to process a source PDF file with references to external objects.

### DESCRIPTION OF THE EXEMPLARY EMBODIMENTS

For the purposes of promoting an understanding of the principles of the invention, reference will now be made to the preferred exemplary embodiments/best mode illustrated in the drawings and specific language will be used to describe the same. It will nevertheless be understood that no limitation of the scope of the invention is thereby intended, and such alterations and further modifications in illustrated embodiments and such further applications of the principles of the invention as illustrated as would normally occur to one skilled in the art to which the invention relates are included herein.

According to one exemplary embodiment, it is initially determined whether at least one reference to an external object is included in the source PDF file. If this is the case, a target PDF file is generated, wherein all referenced external objects are included as embedded objects in this target PDF file.

It is hereby achieved that the target PDF file itself includes all necessary data, and no external references at all are included anymore in the target PDF file. It is thus internally consistent and does not require additional files from which data must be loaded for correct presentation and further processing. This target PDF file may thus be edited like any “normal” PDF file, and in particular may be printed out.

The target PDF file is in particular converted into print data and transmitted to a printer via which the target PDF file may be printed. Alternatively, instead of processing via a printer for printing the PDF file, the target PDF file may also be used to display the pages of the source PDF file without error, inclusive of the included references. Any further type of additional processing of the generated target PDF file is also possible.

If, in the original check as to whether the PDF file includes references to external objects, it was determined that no external reference is present, the source PDF file is directly processed further, meaning that no target PDF file is created; rather, the source PDF file is directly used (for printing, for example). In this way, an unnecessary effort to create new files is avoided since the corresponding problems consequently cannot occur given source PDF files without external reference.

In a particularly preferred embodiment, the pages of the source PDF file are examined per page in succession for the presence of references to external objects. If such an external reference is present, the corresponding external objects are embedded. In this way, a more certain, simple processing is achieved.

The external objects may in particular be pages of external PDF files, images (for example in JPG or TIFF format) and/or ICC profiles.

In a particularly preferred embodiment of the invention, a transitional PDF file is initially generated that includes the pages of the source PDF file and additional pages with the referenced external objects. In particular, before every page of the source PDF file an additional page is hereby inserted on which are included at least a portion of (preferably all) referenced external objects that are referenced in the form of an external reference on the corresponding following page of the source PDF file. In particular, only external objects of a specific type may also be copied onto the additional pages. In particular, the external objects are hereby read out from the external files (in which they are originally contained) and are copied into the transitional PDF file, such that this now contains all data. Alternatively, the additional pages with the referenced objects may also be respectively inserted after the corresponding page of the source PDF file.

It is also advantageous if a unique object ID is associated with each of the objects incorporated into the additional pages. It hereby becomes possible that, in a next step, the original external references on the pages taken from the source PDF file into the transitional PDF file may be replaced with new references, wherein these new references are directed towards the objects incorporated on the additional pages, and in particular are formed via the object ID. It is hereby achieved that the external references are replaced by internal pointers to the corresponding objects now contained in the same PDF file, and thus the external files are no longer required for the correct presentation or further processing.

After all external references have been accordingly replaced, in particular all additional pages inserted into the transitional PDF file—thus those pages with the embedded objects—are removed, wherein the target PDF file results via this removal. In particular, a new file is hereby generated as a target PDF file that is cleaned of the references. Alternatively, it may also be the case that no new file is generated as a target PDF file; rather, the target PDF file is the same file as the transitional PDF file, only the pages that are alternatively additionally inserted are removed from the transitional PDF file again. In spite of the removal of the pages, the actual data of the objects contained on the pages remain present via the corresponding object IDs, such that the pages of the source PDF file may be displayed in the target PDF file together with the corresponding embedded objects. The target PDF file thus in particular has the same page count as the source PDF file.

In order to be able to execute the previously described steps, in particular a first list and/or a second list are created during the processing of the individual pages. All referenced external objects are preferably listed in the first list, in particular with their respective reference names, their respective page index, their respective bounding box, their respective matrix and/or the corresponding object ID. The page index is necessary since the external reference may also be directed to PDF files with multiple pages, wherein only one of these pages is referenced.

The second list in particular lists, for each page of the source PDF file, the references contained in it. Preferably listed herein are, respectively: the reference name with the corresponding page index; the respective object ID; and/or a unique resource ID. Via this information it should be achieved that the objects may be located quickly so that a fast display or further processing is ensured.

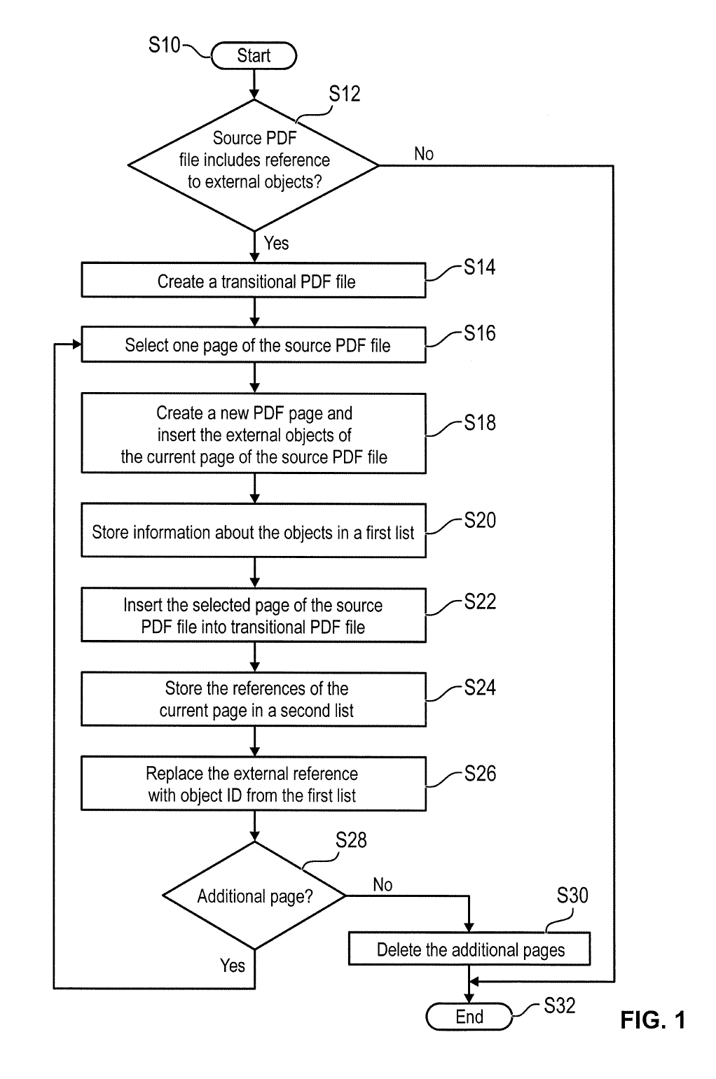

Additional features and advantages of the exemplary embodiments are described in connection with FIG. 1 where a method to process a source PDF file is shown.

After the method has been started in step S10, in step S12 it is checked whether the source PDF file includes at least one reference to an external object in an external file. Given PDF documents it is possible to provide references to external files as form objects. For example, a reference to a page of a different PDF file, to an image and/or to an ICC profile may hereby result. For example, this takes place in the “PDF-VT2” PDF standard.

If it should result in step S12 that the source PDF file includes no reference to an external object, the method is ended immediately in step S32 since the source PDF file may be used for further processing without changes. In particular, the source PDF file may then be printed by means of standard methods without there being any fear that problems could occur in the printing.

However, if it should result in step S12 that at least one reference to an external object is included in the source PDF file, the following steps are executed in order to generate the target PDF file in which references to external objects are no longer included, since such references may otherwise result in problems in the further processing of the PDF file (in particular its printout).

First, what is known as a transitional PDF file is created in step S14 before a page of the source PDF file is selected in step S16. In particular, the first page of the source PDF file is selected first.

A new page in the transitional PDF file is subsequently created in step S18, in which new page are embedded all external objects which are referenced in the selected current page of the source PDF file. For this, in particular the corresponding data are read out from the external file in which the external object is stored and the data are copied into the transitional PDF file. Should multiple references be present in the selected page, it is alternatively also possible that multiple additional pages are inserted into the transitional PDF file, wherein in particular any page includes precisely one referenced object. In an alternative embodiment, not all external objects of the selected current page but rather only a portion thereof—for example only objects of selected, predetermined object types—may be embedded in the new page.

In Step S20, information about the external objects embedded into the newly inserted page is subsequently stored in a first list. This first list includes all external objects which are referenced in the source PDF file. For every external object, a reference name and an associated page index are stored in the list. The page index indicates to which page of an external file the reference refers. This is necessary since a reference to a multi-page PDF file may occur. Moreover, the respective bounding box and/or matrix belonging to the respective external object may also be stored in the list. In addition to the reference names and the page index, an object ID that is respectively unique is associated with every external object. Each unit—made up of reference name in connection with each page index, bounding box and matrix—is only incorporated into the first list once, even if the same page of an external file is referenced multiple times in the source PDF file, whereby the number of entries—and thus the effort—are reduced.

After all external objects have been accepted from the current page into the first list in step S20, in step S22 the selected current page of the source PDF file is inserted into the transitional PDF file so that the transitional PDF file includes as an odd page the respective referenced object of the following even page.

In step S24, which references are present in the page inserted into step S22 is subsequently stored in a second list. For each page of the source PDF file, the reference name with the associated page index which is referenced is thus hereby stored in the second list. The respective associated object IDs previously established via the first list, and possibly additional information that is required for unique identification of a reference (a resource ID, for example), are additionally also stored in the second list.

In step S26, for the current page of the source PDF file that is inserted into the transitional PDF file, the references that it contains to external objects are replaced with the corresponding internal pointers to the corresponding objects now included within the transitional PDF file. It is hereby achieved that this page of the source PDF file now no longer has external references, but nevertheless all embedded objects are present. For this, in step S26—in particular for every new entry of the second list—the pointer to the external object from the source PDF file is replaced with the corresponding pointer to the corresponding object of the first list that is now embedded. In particular, this pointer that now occurs takes place via the object ID, which enables a unique association of the embedded objects.

In step S28, a check is subsequently made as to whether the source PDF file still includes an additional page that has yet to be processed. If this is the case, the method is continued again with step S16 in that now this additional page of the source PDF file is selected as a current page and the following steps S18 through S26 are implemented again. A per-page processing of the source PDF file occurs in this manner.

In an alternative method, instead of a per-page processing of the steps S16 through S26, it is also possible that only the detection of the respective information and the entry in the individual lists initially take place for all pages of the source PDF file, before the corresponding composition of the transitional PDF file takes place for all pages in a downstream step via the insertion of the additional page with the external objects and the modification of the references in the page accepted from the source PDF file.

It is likewise possible that the steps S16 through S26 are implemented only for those pages in which references to external objects are also contained. For those pages in which no such references are present, the pages are simply inserted at the corresponding point into the transitional PDF file without a preceding additional page being incorporated. Alternatively, an additional page may also be transitionally incorporated for each page of the source PDF file, wherein the page remains blank in the event that no reference to an external object is present on the associated page of the source PDF file.

If it results in step S28 that no page that has not yet been processed and incorporated into the transitional PDF file is present anymore in the source PDF file, the method continues with step S30. In this step S30, a cleaning of the transitional PDF file takes place whereby the target PDF file then results. In this cleaning, the pages with the external objects—which pages are additionally inserted in step S18—are deleted again. Since the corresponding data of these external objects are included as before in the source PDF file and—via the corresponding object ID and its pointer in step S26—are present as before at the corresponding points of the pages accepted from the source PDF file, the objects on these pages may accordingly be displayed without error as before. The target PDF file thus in particular has just as many pages as the source PDF file. The target PDF file is hereby in particular a new file in which the reference points as well as the additionally inserted pages are removed.

Alternatively, the target PDF file may not represent a new file but rather is ultimately the same file as the transitional PDF file, only with the additional transitionally inserted pages being removed from it again.

After the cleaning, the method ends in step S32.

The target PDF file that is now obtained may in particular be used for printing out the PDF pages in that it is converted into print data with a corresponding output program and transferred to a printer.

In an alternative embodiment, before the end of the method—in particular after step S28 or S30—a check may be made as to whether the transitional PDF file or target PDF file still contains references to external objects. In particular, this may occur if a PDF page of an external PDF file which was referenced in the source PDF file itself contains a reference to an external object. Should the transitional PDF file or target PDF file include at least one reference to external objects, the previously described method is repeated, wherein the transitional PDF file or target PDF file is used as a new source PDF file. In particular, this loop is repeated until the transitional PDF file or target PDF file no longer contains references to external objects.

It may likewise be necessary to run through the method multiple times if a file contains references to itself.

Via the previously described method it is achieved that, for the operator of a printer, it is insignificant whether his PDF files to be printed include references to external objects from external PDF files or not. Via the merging of the data of the spoiler gradient and the data of the referenced external objects of the external PDF files into the new target PDF file, the PDF document may be processed further—and in particular may be printed—like “normal” PDF files, thus PDF files without references to external objects. It is thus ensured that in particular files of the PDF-VT2 PDF standard may also be processed without problems.

Although preferred exemplary embodiments are shown and described in detail in the drawings and in the preceding specification, they should be viewed as purely exemplary and not as limiting the invention. It is noted that only preferred exemplary embodiments are shown and described, and all variations and modifications that presently or in the future lie within the protective scope of the invention should be protected.

We claim as our invention:

1. A method to print a source PDF file with at least one reference to an external object, comprising the steps of:
Initially determining whether at least one reference to an external object is included in the source PDF file;
generating a target PDF file in the event that at least one reference is included wherein in addition to information of the source PDF file, all referenced external objects are included in the target PDF file in an embedded form;
converting the target PDF file into print data; and
printing the target PDF file.

2. The method according to claim 1 in which the source PDF file is used without modification and is printed if the source PDF file includes no reference to an external object.

3. The method according to claim 1 in which pages of the source PDF file are examined successively page by page, and the external objects are embedded into the target PDF file.

4. The method according to claim 1 in which a transitional PDF file is initially generated that includes pages of the source PDF file and additional pages with the referenced objects.

5. The method according to claim 4 in which one of said additional pages is inserted into the transitional PDF file before every page of the source PDF file, and in said one additional page at least a portion of the referenced objects referenced on a following page in the form of an external reference is included.

6. The method according to claim 4 in which the referenced objects are read out from external files in which they are originally contained and are copied into the transitional PDF file.

7. The method according to claim 4 in which a unique object ID is associated with each referenced object incorporated into the additional pages, and in which an external reference on pages extracted from the source PDF file is replaced with aid of the unique object ID with a reference to the objects incorporated into the additional pages.

8. The method according to claim 7 in which the additional pages are subsequently removed again, whereby the target PDF file results having a page count which coincides with a page count of the source PDF file.

9. The method according to claim 1 in which a first list is created in which are listed all referenced external objects.

10. The method according to claim 9 in which at least one of a respective reference name, respective page index, and associated unique object ID of the referenced external objects is provided in the first list.

11. The method according to claim 9 in which a second list is created in which, for every page of the source PDF file, the references contained therein are listed.

12. The method according to claim 11 in which at least one of a respective reference name, a respective page index, a respective object ID, and associated unique object ID of the references is provided in the second list.

13. A method to print a source PDF file, comprising the steps of:
initially determining whether at least one reference to an external object is included in the source PDF file;
generating a target PDF file in the event that at least one reference is included wherein in addition to information of the source PDF file, all referenced external objects are included in the target PDF file in an embedded form, the target PDF file being generating by use of a transitional PDF file that includes pages of the source PDF file and additional pages with the referenced objects;
converting the target PDF file into print data; and
printing the target PDF file.
